(19) United States
(12) Patent Application Publication
(10) Pub. No.: US 2026/0046057 A1
(43) Pub. Date: Feb. 12, 2026

(54) JAMMING DETECTION FOR VEHICLES

(71) Applicant: GM GLOBAL TECHNOLOGY OPERATIONS LLC, Detroit, MI (US)

(72) Inventors: Alex Jose Veloso, Rochester Hills, MI (US); Scott T. Droste, West Bloomfield, MI (US); George Knish, Rochester Hills, MI (US); Lakshmi V. Thanayankizil, Troy, MI (US); Ron Y. Asmar, West Bloomfield, MI (US); Aaron Adler, Rochester Hills, MI (US)

(73) Assignee: GM GLOBAL TECHNOLOGY OPERATIONS LLC, Detroit, MI (US)

(21) Appl. No.: 18/799,586

(22) Filed: Aug. 9, 2024

(51) Int. Cl. H04K 3/00; B60W 10/06; B60W 10/20; H04L 41/0681; H04W 24/08; H04W 88/06

(52) U.S. Cl. CPC H04K 3/80; B60W 10/06; B60W 10/20; H04L 41/0681; H04W 24/08; B60W 2556/45; H04K 2203/22; H04W 88/06

(57) ABSTRACT

In an exemplary embodiment, a method for detecting a jamming event for a vehicle is provided, the method including transmitting a plurality of null packets via intra-vehicle communications from a first short range wireless communications system of the vehicle to a second short range wireless communications system of the vehicle; monitoring, via a processor of the vehicle using sensor data from one or more sensors of the vehicle, which of the null packets that are transmitted by the first short range wireless communications system are actually received by the second short range wireless communications system; determining, via the processor, a frequency with which the null packets submitted from the first short range wireless communications system are actually received by the second short range wireless communications system; and determining, via the processor, whether a jamming event has occurred for the vehicle, based on the frequency.

### TECHNICAL FIELD

The technical field generally relates to vehicles, and more particularly relates to methods and systems for detecting jamming of vehicles, and for taking vehicle control actions in response to such detected jamming.

Today, certain individuals may attempt to interfere with communications of a vehicle by jamming communications of the vehicle. However, such existing techniques may not always provide optimal detection and action with respect to such jamming occurrences.

Accordingly, it may be desirable to provide improved methods and systems for detecting jamming of vehicle communications, and for taking vehicle control actions in response to such detected jamming.

### SUMMARY

In accordance with an exemplary embodiment, a method for detecting a jamming event for a vehicle is provided, the method including transmitting a plurality of null packets via intra-vehicle communications from a first short range wireless communications system of the vehicle to a second short range wireless communications system of the vehicle; monitoring, via a processor of the vehicle using sensor data from one or more sensors of the vehicle, which of the null packets that are transmitted by the first short range wireless communications system are actually received by the second short range wireless communications system; determining, via the processor, a frequency with which the null packets submitted from the first short range wireless communications system are actually received by the second short range wireless communications system; and determining, via the processor, whether a jamming event has occurred for the vehicle, based on whether the null packets are received.

Also in an exemplary embodiment, the method further includes taking a vehicle control action, in accordance with instructions provided by the processor, when it is determined by the processor that a jamming event has occurred.

Also in an exemplary embodiment, the first short range wireless communications system utilizes a first antenna that is disposed at a front end of the vehicle; and the second short range wireless communications system utilizes a second antenna that is disposed at a rear end of the vehicle, opposite the front end.

Also in an exemplary embodiment, the transmitting of the plurality of null packets includes transmitting the plurality of null packets via intra-vehicle communications under multiple different communication conditions from the first short range wireless communications system of the vehicle to the second short range wireless communications system of the vehicle; the monitoring includes monitoring, via the processor using the sensor data from the one or more sensors of the vehicle, which of the null packets that are transmitted by the first short range wireless communications system are actually received by the second short range wireless communications system at each of the multiple different communication conditions; the determining of the frequency includes determining, via the processor, the frequency with which the null packets submitted from the first short range wireless communications system are actually received by the second short range wireless communications system at each of the multiple different communication conditions; and the determining of whether a jamming event has occurred includes determining, via the processor, whether a jamming event has occurred for the vehicle, based on the frequency at each of the multiple different communication conditions.

Also in an exemplary embodiment, the jamming event is determined to have occurred when the frequency is less than fifty percent or a calibratable threshold.

Also in an exemplary embodiment, the first short range wireless communications system includes a first Wi-Fi radio system; the second short range wireless communications system includes a second Wi-Fi radio system; and the multiple different communication conditions include a plurality of different operating frequencies for the first and second Wi-Fi radio systems.

Also in an exemplary embodiment, the null packets are transmitted from the first Wi-Fi radio system to the second Wi-Fi radio system internal to the vehicle when an engine of the vehicle is turned on.

Also in an exemplary embodiment, the multiple different communication conditions include a first operating frequency of 2.4 GHz for the first and second Wi-Fi radio systems; and a second operating frequency of 5 GHz for the first and second Wi-Fi radio systems.

Also in an exemplary embodiment, the first short range wireless communications system includes a first Bluetooth low energy (BLE) radio system; the second short range wireless communications system includes a second BLE radio system; and the multiple different communication conditions include a plurality of different operating channels for the first and second BLE radio systems.

Also in an exemplary embodiment, the null packets are transmitted from the first BLE radio system to the second BLE radio system when an engine of the vehicle is turned off.

Also in an exemplary embodiment, the multiple different communication conditions include a first operating channel 37, corresponding to 2402 MHz, for the first and second BLE radio systems; and a second operating channel 38 or 39, corresponding to 2426 or 2480 MHz, for the first and second BLE radio systems.

Also in an exemplary embodiment, the multiple different communication conditions include a first operating channel 37, corresponding to 2402 MHz, for the first and second BLE radio systems; and multiple second operating channels 38 and 39, corresponding to both 2426 and 2480 MHz, for the first and second BLE radio systems.

Also in an exemplary embodiment, the method further includes initiating a channel of communications between the vehicle and a remote server that is remote from the vehicle, via a cellular communications system of the vehicle utilizing a cellular network in accordance with instructions provided by the processor; monitoring a heartbeat of continuous communications between the vehicle and the remote server along the cellular network, via the processor; and confirming whether or not the jamming event has actually occurred, based on the monitoring of the heartbeat of the continuous communications between the vehicle and the remote server along the cellular network via the processor.

In another exemplary embodiment, a method is provided for detecting a jamming event for a vehicle, the method including providing communications between the vehicle and a remote server that is remote from the vehicle, via a long range communications system of the vehicle utilizing a wireless network in accordance with instructions provided by a processor of the vehicle; monitoring a heartbeat of continuous communications between the vehicle and the remote server along the wireless network, via the processor; determining, via the processor using sensor data obtained from one or more sensors of the vehicle, one or more quantitative measures pertaining to the heartbeat of continuous communications between the vehicle and the remote server along the wireless network via the processor; and determining, via the processor, whether a jamming event has occurred against the vehicle, based on the one or more quantitative measures pertaining to the heartbeat of continuous communications between the vehicle and the remote server along the wireless network.

Also in an exemplary embodiment, the method further includes taking a vehicle control action, in accordance with instructions provided by the processor, when it is determined by the processor that a jamming event has occurred.

Also in an exemplary embodiment, the heartbeat of continuous communications are provided between a cellular communications system of the vehicle and the remote server using a cellular network in accordance with instructions provided by the processor.

Also in an exemplary embodiment, the one or more quantitative measures used to determine whether a jamming event has occurred include one or more of a received signal strength indicator (RSSI), a reference signal received quality (RSRQ), or both, of signals that are sent from the cellular communications system of the vehicle to the remote server using the cellular network.

Also in an exemplary embodiment, the one or more quantitative measures used to determine whether a jamming event has occurred include both (i) a received signal strength indicator (RSSI); and (ii) a reference signal received quality (RSRQ), or both, of signals that are sent from the cellular communications system of the vehicle to the remote server using the cellular network.

Also in an exemplary embodiment, the method further includes confirming, via the processor, whether a jamming event has occurred against the vehicle, based on monitoring of intra-vehicle transmissions between multiple short range wireless communications systems of the vehicle that are disposed on opposing sides of the vehicle.

In another exemplary embodiment, a vehicle is provided that includes a bod; a first short range wireless range communications system with a first antenna disposed at a front end of the body, the first short range wireless communications system including a Wi-Fi radio system or a Bluetooth lower energy (BLE) system; a second short range wireless communications system with a second antenna disposed at a rear end of the body, opposite the front end, the first short range wireless communications system also including a Wi-Fi radio system or a Bluetooth lower energy (BLE) system; a long range cellular communications system including a cellular antenna disposed on the body; a plurality of sensors configured to monitor communications of the first short range wireless communications system, the second short range wireless communications system, and the long range cellular communications system and to generate sensor data based on the monitoring; and a processor that is coupled to the first short range wireless communications system, the second short range wireless communications system, the long range cellular communications system, and the plurality of sensors, the processor configured to at least facilitate instructing the first short range wireless communications system to transmit a plurality of null packets via intra-vehicle communications to the second short range wireless communications system of the vehicle under multiple different communication conditions including multiple different transmission frequency levels, multiple different operating channels, or both; monitoring, using the sensor data, which of the null packets that are transmitted by the first short range wireless communications system are actually received by the second short range wireless communications system, under each of the multiple different communication conditions; determining a frequency with which the null packets submitted from the first short range wireless communications system are actually received by the second short range wireless communications system; performing, via the processor, an initial determination as to whether a jamming event has occurred for the vehicle, based on the frequency, via the monitoring at each of the multiple different communication conditions; initiating a channel of communications between the vehicle and a remote server that is remote from the vehicle, via the long range cellular communications system of the vehicle utilizing a cellular network in accordance with instructions provided by the processor; monitoring a heartbeat of continuous communications including signals between the vehicle and the remote server along the cellular network; and determining a plurality of quantitative measures, including both (i) a received signal strength indicator (RSSI); and (ii) a reference signal received quality (RSRQ), of the signals that are sent from the long range cellular communications system of the vehicle to the remote server using the cellular network; confirming whether or not the jamming event has actually occurred, based on the monitoring of the heartbeat of the continuous communications between the vehicle and the remote server along the cellular network, including based on the RSSI and the RSRQ; and taking a vehicle control action, including by inhibiting operation of a steering column, engine, or both, of the vehicle, when it is determined by the processor that a jamming event has occurred against the vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a communications system that includes a vehicle having a control system that is configured to detect vehicle jamming and to initiate a vehicle control action in response to detected vehicle jamming, in accordance with an exemplary embodiment;

FIG. 2 is a functional block diagram that includes the control system of the vehicle of the communications system of FIG. 1, in accordance with an exemplary embodiment; and

FIG. 3 is a method for detecting vehicle jamming and initiating vehicle control actions in response to detected vehicle jamming, and that can be implemented in connection with the communications system of FIG. 1 and the control system of FIGS. 1 and 2, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

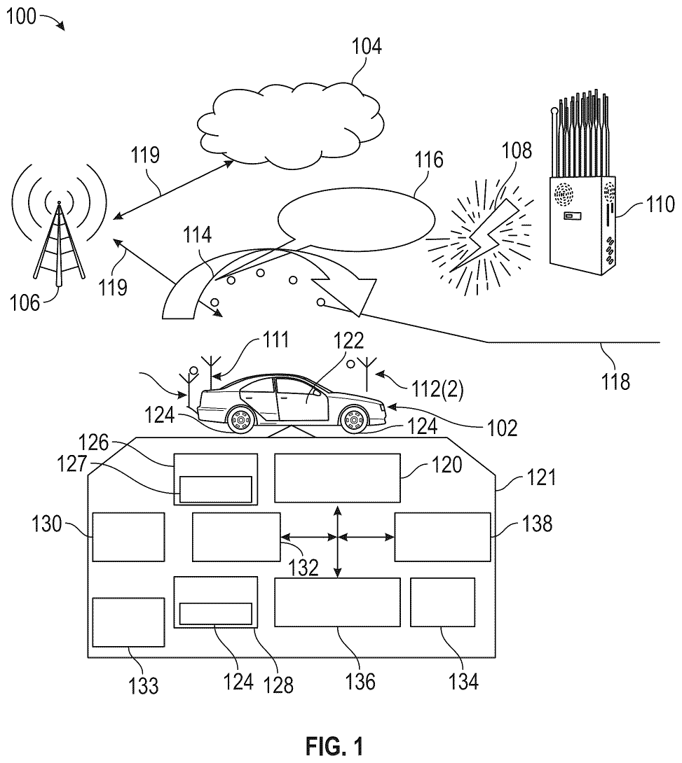

FIG. 1 is a functional block diagram of a communications system 100, in accordance with an exemplary embodiment. As described in greater detail further below, the communications system 100 includes a vehicle that includes a control system 120 that is configured for detecting a jamming event 108 for the vehicle 102 (e.g., from a third party jamming device 110 in proximity to the vehicle 102 that is used against the vehicle 102), and for taking vehicle control actions in response to such detected jamming.

As depicted in FIG. 1, the communications system 100 generally includes the vehicle 102, along with one or more wireless communications networks 106, and a remote server 104. It should be appreciated that the overall architecture, setup, and operation, as well as the individual components of the illustrated communications system 100 are merely exemplary and that differently configured communications systems may also be utilized to implement the examples of the method disclosed herein. Thus, the following paragraphs, which provide a brief overview of the illustrated communications system 100, are not intended to be limiting.

The vehicle 102 may be any type of mobile vehicle such as an automobile, motorcycle, car, truck, recreational vehicle (RV), boat, plane, farm equipment, watercraft, aircraft, spacecraft, or the like, and is equipped with suitable hardware and software that enables it to communicate over communications system 100.

As shown in FIG. 1, the vehicle 102 includes a body 122 as well as various antennas 111, 112(1), and 112(2) disposed on the body 122. In the depicted embodiment, the antennas include a long range antenna 111, a first short range antenna 112(1), and a second short range antenna 112(2). As depicted in FIG. 1, in various embodiments, the long range antenna 111 and the first and second short range antennas 112(1) and 112(2) are each disposed on or proximate a roof or upper portion of the body 122 of the vehicle 102; however, this may vary in other embodiments. Also as depicted in FIG. 1, in various embodiments, the first and second short range antennas 112(1) and 112(2) are disposed on or near opposing ends of the vehicle 102. Specifically, in the depicted embodiment, the first short range antenna 112(1) is disposed at or near a rear end of the vehicle 102, whereas the second short range antenna 112(2) is disposed at or near a front end of the vehicle 102.

In various embodiments, the long range antenna 111 comprises a cellular antenna 111 that is configured for communications between the vehicle 102 and the remote server 104 via the communications network 106. Also in various embodiments, the communications network 106 comprises a cellular communications network 106 that provides cellular links 119 for wireless communications between the vehicle 102 and the remote server 104.

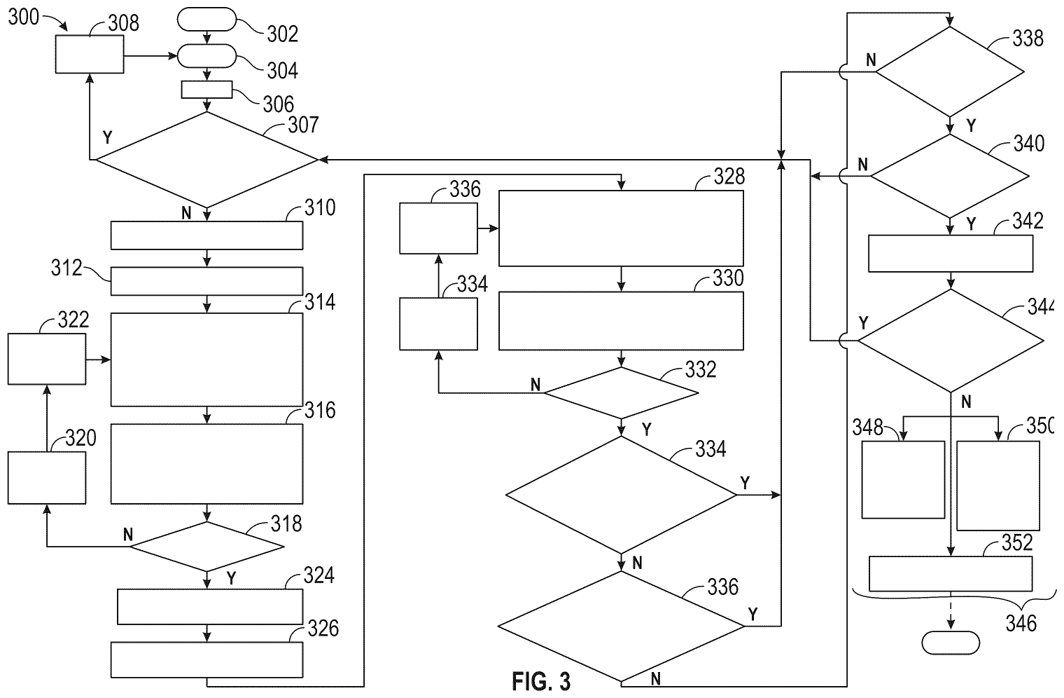

In various embodiments, the first short range antenna 112(1) and the second short range antenna 112(2) are configured for intra-vehicle communications therebetween for the vehicle 102, including for encrypted communication 116 featuring the exchange of null packets 118 therebetween that are used for detecting a jamming event 108 against the vehicle 102 from a third party jamming device 110, including as described in greater detail further below in connection with the FIG. 3. In an embodiment, the first short range antenna 112(1) and the second short range antenna 112(2) comprise first and second Wi-Fi antennas. In a second embodiment, the first short range antenna 112(1) and the second short range antenna 112(2) comprise first and second Bluetooth low energy (BLE) antennas.

Also as depicted in FIG. 1, the vehicle 102 further includes a plurality of wheels 124 that are each rotationally coupled to a chassis near a respective corner of the body 122 to facilitate movement of the vehicle 102.

In addition, also as shown in FIG. 1, in various embodiments the vehicle 102 further includes vehicle hardware 121 (e.g., including various systems, apparatus, and devices of the vehicle 102) that is disposed within the body 122 of the vehicle 102. As depicted in FIG. 1, in various embodiments the vehicle hardware 121 includes the above-referenced control system 120, in addition to a drive system 126, a steering system 128, a brake system 130, a lock module 132, a display system 133, and an alarm system 134 with an alarm control module 136, among various other modules 138.

In various embodiments, the drive system 126 drives the wheels 124 for movement of the vehicle 102. In certain embodiments, the drive system 126 comprises a propulsion system having one or more engines 127.

Also in various embodiments, the lock module 132 controls and inhibits movement and operation of the vehicle 102 when a jamming event is detected. In certain embodiments, the lock module 132 locks and/or otherwise restricts or inhibits operation of the engine 127 and/or the steering column 129 when a jamming event is detected for the vehicle 102.

In various embodiments, the display system 133 provides notifications of vehicle conditions and events, including for a driver and/or other passengers of the vehicle 102 and/or for others in proximity to the vehicle 102. In various embodiments, the display system 133 may provide audio, visual, haptic, and/or other types of notifications, including when a jamming event is detected for the vehicle 102.

In various embodiments, the alarm system 134 provides notifications of vehicle circumstances and events, including jamming events against the vehicle 102. In certain embodiments, the alarm system 134 may be part of or coupled to the display system 133. Also in certain embodiments, the alarm system 134 is controlled in whole or in part by the alarm control module 136.

In various embodiments, the other modules 138 may include any number of other vehicle systems, such as, by way of example, an engine control module, along with one or more infotainment systems, climate control systems, lighting systems, and so on, for the vehicle 102.

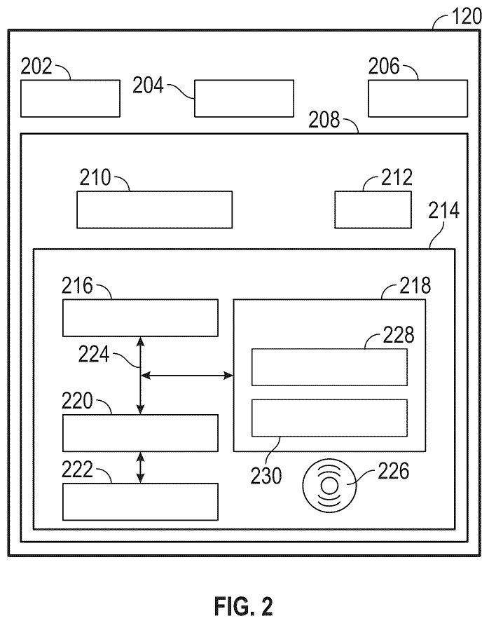

FIG. 2 is a functional block diagram that includes the control system 120 of the vehicle 102 of the communications system 100 of FIG. 1, in accordance with an exemplary embodiment. In certain embodiments, the control system 120 comprises a telematics system for the vehicle 102 and/or is coupled thereto.

As depicted in FIG. 2, in various embodiments, the control system 120 includes a plurality of wireless communications networks, including: a first short range communications system 202, a second short range communications system 204, and a long range communications system 206, along with a control system 208 that is coupled thereto.

Specifically, in various embodiments, the first short range communications system 202 is coupled to and/or includes the first short range antenna 112(1) of FIG. 1; the second short range communications system 204 is coupled to and/or includes the second short range antenna 112(2) of FIG. 1; and the long range communications system 206 is coupled to and/or includes the long range antenna 111 of FIG. 1.

In various embodiments, the first short range communications system 202 and the second short range communications system 204 are configured to communicate with one another via intra-vehicle communications, including for exchanging packets therebetween for detecting jamming events against the vehicle 102. Also in various embodiments, the long range communications system 206 is configured to communicate with the remote server 104 via the cellular communications network 106, including for confirming whether a jamming attached has occurred against the vehicle 102.

As depicted in FIG. 2, in various embodiments, the control system 208 includes various sensors 210, along with a transceiver 212 and a controller 214.

In various embodiments, the sensors 210 include and/or are coupled to various antennas, such as the long range antenna 111, the first short range antenna 112(1), and the second short range antenna 112(2) of FIG. 1. Also in various embodiments, the sensors 210 further measure and/or evaluate various parameters corresponding to communications of or related to the control system 120, including parameters as to the strength, intensity, and/or quality of signals of the long range communications system 206, and specifically including values of received signal strength indicator (RSSI) and reference signal received quality (RSRQ) of the signals, as well as a power level and/or other parameters associated with intra-vehicle signals sent between the first short range communications system 202 and the second short range communications system 204 of FIG. 2. Also in various embodiments, the sensors 210 are also configured to detect transmission and operational states of the vehicle 102 (including whether the engine 127 is turned off or on), along with a driver's engagement of the brake system 130 and steering system 128, in addition to whether doors of the vehicle 102 are opened or closed, and whether devices such as an onboard diagnostic (OBD) tool is connected to the vehicle 102, along with various other potential sensor data. In addition, in certain embodiments, the sensors 210 also include one or more cameras (e.g., video cameras) and/or microphones for recording activities pertaining to the vehicle 102 when a jamming event is detected.

Also in various embodiments, the transceiver 212 performs and/or facilitates communications for the control system 120, for example within the vehicle 102 and/or outside the vehicle 102, such as with the remote server 104 and/or one or more other locations and/or parties outside the vehicle 102 (e.g., one or more emergency responders, law enforcement authorities, and so on).

As depicted in FIG. 2, in various embodiments, the controller 214 is coupled to the sensors 210, along with the drive system 126, display system 133, and other vehicle systems, and executes the steps of the process 300 of FIG. 3 as described in greater detail further below in connection therewith.

Also as depicted in FIG. 2, in various embodiments, the controller 214 comprises a computer system (also referred to herein as computer system 214), and includes a processor 216, a memory 218, an interface 220, a storage device 222, and a computer bus 224.

The processor 216 performs the computation and control functions of the controller 214, and may comprise any type of processor or multiple processors, single integrated circuits such as a microprocessor, or any suitable number of integrated circuit devices and/or circuit boards working in cooperation to accomplish the functions of a processing unit. During operation, the processor 216 executes one or more programs 228 contained within the memory 218 and, as such, controls the general operation of the controller 214 and the computer system of the controller 214, generally in executing the processes described herein, such as the process 300 of FIG. 3 as described further below in connection therewith.

The memory 218 can be any type of suitable memory, including various types of non-transitory computer readable storage medium. In certain examples, the memory 218 is located on and/or co-located on the same computer chip as the processor 216. In the depicted embodiment, the memory 218 stores the above-referenced program 228 along with stored values 230 (e.g., look-up tables, thresholds, and/or other values with respect to the process 300).

The interface 220 allows communication to the computer system of the controller 214, for example from a system driver and/or another computer system, and can be implemented using any suitable method and apparatus. In one embodiment, the interface 220 obtains the various data from the sensors 210, among other possible data sources. The interface 220 can include one or more network interfaces to communicate with other systems or components. The interface 220 may also include one or more network interfaces to communicate with technicians, and/or one or more storage interfaces to connect to storage apparatuses, such as the storage device 222.

The storage device 222 can be any suitable type of storage apparatus, including various different types of direct access storage and/or other memory devices. In one exemplary embodiment, the storage device 222 comprises a program product from which memory 218 can receive a program 228 that executes one or more embodiments of one or more processes of the present disclosure, such as the steps of the process 300 of FIG. 3 as described further below in connection therewith. In another exemplary embodiment, the program product may be directly stored in and/or otherwise accessed by the memory 218 and/or a disk (e.g., disk 226), such as that referenced below.

The bus 224 serves to transmit programs, data, status and other information or signals between the various components of the computer system of the controller 214. The bus 224 can be any suitable physical or logical means of connecting computer systems and components. This includes, but is not limited to, direct hard-wired connections, fiber optics, infrared and wireless bus technologies. During operation, the program 228 is stored in the memory 218 and executed by the processor 216.

It will be appreciated that while this exemplary embodiment is described in the 106 context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 216) to perform and execute the program.

FIG. 3 is a flowchart of a process 300 for detecting vehicle jamming and initiating vehicle control actions in response to detected vehicle jamming, in accordance with an exemplary embodiment. In various embodiments, the process 300 can be implemented in connection with the communications system 100 of FIG. 1, including the vehicle 102 and the control system 120 of FIGS. 1 and 2, among other components of the vehicle 102 and of the communications system 100.

As depicted in FIG. 3, in various embodiments the process 300 begins at 302. In a first exemplary embodiment (e.g., in which the first and second short range communications systems 202 and 204 of FIG. 2 comprise Wi-Fi communications systems (with communications therebetween that are internal to the vehicle), the process 300 begins when an “ignition on” condition is satisfied for the vehicle 102 at 304 (e.g., when the engine 127 is turned on).

With continued reference to FIG. 3, in various embodiments data is obtained (step 306). In various embodiments, during step 306, sensor data is obtained from the sensors 210 of FIG. 2, including communication signals from within the vehicle 102 (e.g., from an engine control module and/or other modules 138 of the vehicle 102) and between the vehicle 102 and the remote server 104, along with related data including as to the signal strength, intensity, and quality with respect to communications between the vehicle 102 and the remote server 104. In certain embodiments, data may also be obtained from the remote server 104 and/or one or more other systems and/or devices from the vehicle 102 and/or outside of the vehicle 102, including via the transceiver 212.

In certain embodiments, a determination is made as to whether the data of step 306 corresponds to a preliminary health check pass (step 307). In certain embodiments, during step 307, a determination is made by one or more processors (such as the processor 216 of FIG. 2) that communications using long range communications system 206 of FIG. 2 via the long range antenna 111 of FIG. 1 satisfy a health check pass (e.g., that these communications are deemed to be performing properly and without interference), and further than intra-vehicle communications (e.g., form an engine control module) similarly satisfy a health check pass.

In certain embodiments, the health check passes may also pertain to whether one or more triggers are satisfied. In one such embodiment, a trigger condition is satisfied when (1) an alarm is triggered, such as via the alarm system 134 and/or alarm control module 136 of FIG. 1, and further provided that (2) one or more of the following additional conditions are also met: (a) a door of the vehicle 102 is opened or closed; (b) a brake pedal of the brake system 130 of the vehicle 102 is engaged; and/or (c) an onboard diagnostic (OBD) tool is connected to the vehicle 102. In certain embodiments, if such a trigger condition is satisfied, then a corresponding health check pass is not satisfied.

In various embodiments, if it is determined in step 307 that one or more of the health check passes are not satisfied, then the process proceeds to step 308. In various embodiments, during step 308, a counter is initiated. Also in various embodiments, after a predetermined amount of time, the process returns to step 304 in a new iteration, and steps 304-308 thereafter repeat in new iterations until a determination is made in an iteration of step 307 that each of the health checks are satisfied. In one embodiment, the predetermined amount of time of step 308 is equal to ten seconds; however, this may vary in other embodiments.

In various embodiments, once a determination is made in an iteration of step 307 that each of the health checks are satisfied, then the process proceeds to step 310, in which a first short range communications system is set to a first setting. In various embodiments, during step 310, the first short range communications system 202 of FIG. 2 is set to a first operational setting via instructions provided by the processor 216 of FIG. 2.

In a first exemplary embodiment in which the first and second short range communications systems 202 and 204 correspond to Wi-Fi radio systems, during step 310 the first short range communications system 202 is set to operate at a first operational frequency. In one such exemplary embodiment, the first operational frequency is equal to 2.4 GHz. However, this may vary in other embodiments.

Also in various embodiments, during step 312, a second short range communications system is set to the first setting. In various embodiments, during step 312, the second short range communications system 204 of FIG. 2 is set to the same first operational setting as the first short range communications system 202, via instructions provided by the processor 216 of FIG. 2.

In a first exemplary embodiment in which the first and second short range communications systems 202 and 204 correspond to Wi-Fi radio systems, during step 312 the second short range communications system 204 is also set to operate at the above-referenced first operational frequency. As noted above, in one such exemplary embodiment, the first operational frequency is equal to 2.4 GHz. However, this may vary in other embodiments.

In various embodiments, null packets are exchanged between the first short range communications system 202 and the second short range communications system 204 (step 314). In various embodiments, null packets are periodically sent between the first short range communications system 202 and the second short range communications system 204. In various embodiments, this is performed in accordance with instructions provided by the processor 216 for the first short range communications system 202 to periodically send null packets to the second short range communications system 204, and for the second short range communications system 204 to receive the null packets by going off channel to that corresponding to the first short range communications system 202.

In various embodiments, an average power level is obtained for the null packets received by the second short range communications system 204 (step 316). In certain embodiments, the average power level is measured via one or more of the sensors 210 of FIG. 2. In certain other embodiments, the average power level is determined via the processor 216 of FIG. 2 using sensor data from the sensors 210 of FIG. 2.

In various embodiments, a counter is initiated as the packets are delivered and received in steps 314-316, and determinations are continuously made at step 318 as to whether the counter has exceeded a predetermined number “N”. In various embodiments, this is performed via the processor 216 of FIG. 2.

In various embodiments, when it is determined at step 318 that the counter has not exceeded the predetermined number “N”, the process proceeds to step 320, in which waiting occurs for a predetermined waiting time. In certain embodiments, the predetermined waiting time of step 320 is equal to one second; however, this may vary in other embodiments. Also in various embodiments, after the waiting of step 320, the counter is then incremented at 322, after which the process returns to step 314. In various embodiments, steps 314-322 repeat in this manner until a determination is made during an iteration of step 318 that the counter has exceeded the predetermined number “N”.

In various embodiments, once it is determined in an iteration of step 318 that the counter has exceeded the predetermined number “N”, the process then proceeds to step 324. In various embodiments, during step 324, a first short range communications system is set to a second setting. In various embodiments, during step 324, the first short range communications system 202 of FIG. 2 is set to a second operational setting via instructions provided by the processor 216 of FIG. 2.

In a first exemplary embodiment in which the first and second short range communications systems 202 and 204 correspond to Wi-Fi radio systems, during step 324 the first short range communications system 202 is set to operate at a second operational frequency that is greater than the first operation frequency of step 310. In one such exemplary embodiment, the second operational frequency is equal to 5 GHz. However, this may vary in other embodiments.

Also in various embodiments, during step 326, a second short range communications system is set to the second setting. In various embodiments, during step 326, the second short range communications system 204 of FIG. 2 is set to the same second operational setting as the first short range communications system 202, via instructions provided by the processor 216 of FIG. 2.

In a first exemplary embodiment in which the first and second short range communications systems 202 and 204 correspond to Wi-Fi radio systems, during step 326 the second short range communications system 204 is also set to operate at the above-referenced second operational frequency. As noted above, in one such exemplary embodiment, the second operational frequency is equal to 5 GHz. However, this may vary in other embodiments.

In various embodiments, null packets are exchanged between the first short range communications system 202 and the second short range communications system 204 (step 328). In various embodiments, null packets are periodically sent between the first short range communications system 202 and the second short range communications system 204. In various embodiments, this is performed in accordance with instructions provided by the processor 216 for the first short range communications system 202 to periodically send null packets to the second short range communications system 204, and for the second short range communications system 204 to receive the null packets by going off channel to that corresponding to the first short range communications system 202.

In various embodiments, an average power level is obtained for the null packets received by the second short range communications system 204 (step 330). In certain embodiments, the average power level is measured via one or more of the sensors 210 of FIG. 2. In certain other embodiments, the average power level is determined via the processor 216 of FIG. 2 using sensor data from the sensors 210 of FIG. 2.

In various embodiments, a counter is initiated as the packets are delivered and received in steps 328-330, and determinations are continuously made at step 331 as to whether the counter has exceeded a predetermined number “N”. In various embodiments, this is performed via the processor 216 of FIG. 2.

In various embodiments, when it is determined at step 331 that the counter has not exceeded the predetermined number “N”, the process proceeds to step 332, in which waiting occurs for a predetermined waiting time. In certain embodiments, the predetermined waiting time of step 332 is equal to one second; however, this may vary in other embodiments. Also in various embodiments, after the waiting of step 332, the counter is then incremented at 333, after which the process returns to step 328. In various embodiments, steps 328-333 repeat in this manner until a determination is made during an iteration of step 331 that the counter has exceeded the predetermined number “N”.

In various embodiments, once it is determined in an iteration of step 331 that the counter has exceeded the predetermined number “N”, the process then proceeds to step 334.

In various embodiments, during step 334, a determination is made as to whether a frequency of null packets received with the first communications settings of steps 310 and 312 exceed a predetermined threshold. In various embodiments, this determination is made by the processor 216 of FIG. 2 based on the sensor data corresponding to the communication transmissions and related actions of steps 310-322. In one exemplary embodiment, the predetermined threshold corresponds to at least fifty percent of the null packets sent from the first short range communications system 202 to be successfully received by the second short range communications system 204, thereby resulting in a ratio to successfully transmitted null packets to total transmitted null packets to be greater than 0.5. However, the predetermined threshold may differ in other embodiments, for example in that one or more other calibratable threshold may also be utilized.

In various embodiments, if the frequency of successfully transmitted null packets with the first communications settings exceeds the predetermined threshold of step 334, then in various embodiments the process returns to step 307, and the process thereafter continues in a new iteration.

Conversely, in various embodiments, if the frequency of successfully transmitted null packets for the first communications settings does not exceed the predetermined threshold of step 334, then in various embodiments the process proceeds instead to step 336, described directly below.

In various embodiments, during step 336, a determination is made as to whether a frequency of null packets received with the second communications settings of steps 324 and 326 exceed a predetermined threshold. In various embodiments, this determination is made by the processor 216 of FIG. 2 based on the sensor data corresponding to the communication transmissions and related actions of steps 324-333. In one exemplary embodiment, the predetermined threshold corresponds to at least fifty percent of the null packets sent from the first short range communications system 202 to be successfully received by the second short range communications system 204, thereby resulting in a ratio to successfully transmitted null packets to total transmitted null packets to be greater than 0.5. However, the predetermined threshold may differ in other embodiments.

In various embodiments, if the frequency of successfully transmitted null packets with the second communications settings exceeds the predetermined threshold of step 334, then in various embodiments the process returns to step 307, and the process thereafter continues in a new iteration.

Conversely, in various embodiments, if the frequency of successfully transmitted null packets for the second communications settings does not exceed the predetermined threshold of step 334, then in various embodiments the process proceeds instead to step 336, described directly below.

In various embodiments, during step 336, a determination is made as to whether a frequency of null packets received with the second communications settings of steps 324 and 326 exceed a predetermined threshold. In various embodiments, this determination is made by the processor 216 of FIG. 2 based on the sensor data corresponding to the communication transmissions and related actions of steps 324-333. In one exemplary embodiment, the predetermined threshold corresponds to at least fifty percent of the null packets sent from the first short range communications system 202 to be successfully received by the second short range communications system 204, thereby resulting in a ratio to successfully transmitted null packets to total transmitted null packets to be greater than 0.5. However, the predetermined threshold may differ in other embodiments.

In various embodiments, if the frequency of successfully transmitted null packets with the second communications settings exceeds the predetermined threshold of step 336, then in various embodiments the process returns to step 307, and the process thereafter continues in a new iteration.

Conversely, in various embodiments, if the frequency of successfully transmitted null packets for the second communications settings does not exceed the predetermined threshold of step 336, then in various embodiments the process proceeds instead to step 338, described directly below.

In various embodiments, during step 338, a determination is made as to whether a first quantitative measure of signals between the long range communications system 206 of FIG. 2 and the remote server 104 of FIG. 2 is less than a predetermined threshold. In various embodiments, this determination is made by the processor 216 of FIG. 2 based on the sensor data corresponding to the cellular communications from the long range communications system 206 to the remote server 104 via the communications network 106 of FIG. 1 (e.g., via a cellular network). Also in one embodiment, the first quantitative measure corresponds to a received signal strength indicator (RSSI) of the cellular communications. However, this may differ in other embodiments.

In various embodiments, if the first quantitative measure (e.g., RSSI) is greater than or equal to the predetermined threshold of step 338, then in various embodiments the process returns to step 307, and the process thereafter continues in a new iteration.

Conversely, in various embodiments, if the first quantitative measure (e.g., RSSI) is less than the predetermined threshold of step 338, then in various embodiments the process proceeds instead to step 340, described directly below.

In various embodiments, during step 340, a determination is made as to whether a second quantitative measure of signals between the long range communications system 206 of FIG. 2 and the remote server 104 of FIG. 2 is less than a predetermined threshold. In various embodiments, this determination is made by the processor 216 of FIG. 2 based on the sensor data corresponding to the cellular communications from the long range communications system 206 to the remote server 104 via the communications network 106 of FIG. 1 (e.g., via a cellular network). Also in one embodiment, the second quantitative measure corresponds to a reference signal received quality (RSRQ) of the cellular communications. However, this may differ in other embodiments.

In various embodiments, if the second quantitative measure (e.g., RSRQ) is greater than or equal to the predetermined threshold of step 340, then in various embodiments the process returns to step 307, and the process thereafter continues in a new iteration.

Conversely, in various embodiments, if the second quantitative measure (e.g., RSRQ) is less than the predetermined threshold of step 340, then in various embodiments the process proceeds instead to step 342, described directly below.

In various embodiments, during step 342, a data channel is opened with the remote server 104. In various embodiments, during step 342, the long range communications system 206 performs a heartbeat communication sequence with the remote server 104 in accordance with instructions provided by the processor 216 of FIG. 2, and the heartbeat communications are monitored by the processor 216 using sensor data as to the heartbeat communication sequence. In various embodiments, a determination is made as to whether the communications with the remote server are operating correctly (step 344). Specifically, in various embodiments, the processor 216 determines whether the heartbeat communication sequence of step 342 is healthy (i.e., that the communications between the vehicle 102 and the remote server 104 via the channel of step 342 are performing successfully). In certain embodiments, the determinations of steps 334-340 comprise one or more initial determinations as to whether a jamming event is likely to be occurring against the vehicle 102, and the communications and monitoring of steps 342 and 344 provide a confirmation, in follow-up to the initial determinations of steps 334-340, as to whether or not a jamming event is actually occurring against the vehicle 102.

In various embodiments, if it is determined in step 344 that the communications with the remote server are operating correctly, then the process returns to step 307, and the process thereafter continues in a new iteration.

Conversely, in various embodiments, if it is instead determined in step 344 that the communications with the remote server are not operating correctly, then in various embodiments one or more vehicle control actions are taken (step 346). In various embodiments, the vehicle control actions are implemented via instructions provided by the processor 216 of FIG. 2.

As illustrated in FIG. 3, in various embodiments, the vehicle control actions include activating one or more alarms in step 348, such as by honking a horn, flashing lights, or other actions of the vehicle via the alarm system 134, alarm control module 136, and/or display system 133 of FIG. 1, and/or by providing communications to law enforcement and/or other authorities via the transceiver 212 of FIG. 2, in accordance with instructions provided by the processor 216 of FIG. 2.

As illustrated in FIG. 3, in various embodiments, the vehicle control actions may also include inhibiting vehicle operation in step 350, such as by prohibiting or inhibiting starting of the engine 127 and/or movement of the steering column 129 of FIG. 1 via the lock module 132, in accordance with instructions provided by the processor 216 of FIG. 2.

Also as illustrated in FIG. 3, in various embodiments, the vehicle control actions may also include initiating of recording of activities pertaining to the vehicle 102 in step 352, such as by performing audio and/or video recordings. In various embodiments, this is performed via cameras and/or microphones of the sensors 210 of FIG. 2, in accordance with instructions provided by the processor 216 of FIG. 2

In various embodiments, the process then terminates at 354.

Accordingly, in various embodiments, methods and systems are provided for detecting jamming events against a vehicle, and for taking appropriate vehicle control actions in response to the jamming event.

With continued reference to FIG. 3, in a second exemplary embodiment, the first and second short range communications systems 202 and 204 of FIG. 2 comprise BLE communications systems, rather than Wi-Fi systems. This second embodiment may include some differences for the process 300, for example as described below.

In this second exemplary embodiment in which the first and second short range communications systems 202 and 204 of FIG. 2 comprise BLE communications systems, the process 300 may instead begin when an “ignition off” condition is satisfied for the vehicle 102 at 304 (e.g., when the engine 127 is turned off), and/or regardless of whether the engine 127 is turned on or off in certain embodiments (e.g., with continuous monitoring of the BLE communications in certain embodiments).

Also in this second exemplary embodiment in which the first and second short range communications systems 202 and 204 correspond to BLE radio systems, during step 310 the first short range communications system 202 is set to operate at a first operational channel. In one such exemplary embodiment, the first operational channel corresponds to Channel 37, corresponding to 2402 MHz. However, this may vary in other embodiments.

Also in this second exemplary embodiment in which the first and second short range communications systems 202 and 204 correspond to BLE radio systems, during step 312 the second short range communications system 204 is also set to operate at the first operational channel (i.e., the same channel as the first short range communications system 202). As noted above, in one such exemplary embodiment, the first operational channel corresponds to Channel 37. However, this may vary in other embodiments.

Also in this second exemplary embodiment in which the first and second short range communications systems 202 and 204 correspond to BLE radio systems, during step 324 the first short range communications system 202 is set to operate at one or more second operational channels that are different to the operational channel of step 310. In one such exemplary embodiment, the second operational channels correspond to Channel 38 (corresponding to 2426 MHz), Channel 39 (corresponding to 2480 MHz), or both. However, this may vary in other embodiments.

Also in this second exemplary embodiment in which the first and second short range communications systems 202 and 204 correspond to BLE radio systems, during step 326 the second short range communications system 204 is also set to operate at the same second one or more operational channels (i.e., the same channel(s) as the first short range communications system 202). As noted above, in one such exemplary embodiment, the second operational channel(s) correspond to Channel 37, Channel 38, or both. However, this may vary in other embodiments.

It will be appreciated that the systems and methods may vary from those depicted in the Figures and described herein. For example, the communications system 100 of FIG. 1, including the vehicle 102 thereof and the control system 120 and other components thereof, and including the control system 120 details of FIG. 2, may vary from that depicted in FIGS. 1 and 2 and/or described herein, in various embodiments. It will also be appreciated that the process (and/or subprocesses) disclosed herein may differ from those described herein and/or depicted in FIG. 3, and/or that steps thereof may be performed simultaneously and/or in a different order as described herein and/or depicted in FIG. 3, among other possible variations.

While at least one example has been presented in the foregoing detailed description, it should be appreciated that a vast number of variations exist. It should also be appreciated that the example or examples are only examples, and are not intended to limit the scope, applicability, or configuration of the disclosure in any way. Rather, the foregoing detailed description will provide those skilled in the art with a convenient road map for implementing the example or examples. It should be understood that various changes can be made in the function and arrangement of elements without departing from the scope of the appended claims and the legal equivalents thereof.

What is claimed is:

1. A method for detecting a jamming event for a vehicle, the method comprising:
transmitting a plurality of null packets via intra-vehicle communications from a first short range wireless communications system of the vehicle to a second short range wireless communications system of the vehicle;
monitoring, via a processor of the vehicle using sensor data from one or more sensors of the vehicle, which of the null packets that are transmitted by the first short range wireless communications system are actually received by the second short range wireless communications system;
determining, via the processor, a frequency with which the null packets submitted from the first short range wireless communications system are actually received by the second short range wireless communications system; and
determining, via the processor, whether a jamming event has occurred for the vehicle, based on whether the null packets are received.

2. The method of claim 1, further comprising:
taking a vehicle control action, in accordance with instructions provided by the processor, when it is determined by the processor that a jamming event has occurred.

3. The method of claim 1, wherein:
the first short range wireless communications system utilizes a first antenna that is disposed at a front end of the vehicle; and
the second short range wireless communications system utilizes a second antenna that is disposed at a rear end of the vehicle, opposite the front end.

4. The method of claim 1, wherein:
the transmitting of the plurality of null packets comprises transmitting the plurality of null packets via intra-vehicle communications under multiple different communication conditions from the first short range wireless communications system of the vehicle to the second short range wireless communications system of the vehicle;
the monitoring comprises monitoring, via the processor using the sensor data from the one or more sensors of the vehicle, which of the null packets that are transmitted by the first short range wireless communications system are actually received by the second short range wireless communications system at each of the multiple different communication conditions;
the determining of the frequency comprises determining, via the processor, the frequency with which the null packets submitted from the first short range wireless communications system are actually received by the second short range wireless communications system at each of the multiple different communication conditions; and
the determining of whether a jamming event has occurred comprises determining, via the processor, whether a jamming event has occurred for the vehicle, based on the frequency at each of the multiple different communication conditions.

5. The method of claim 4, wherein the jamming event is determined to have occurred when the frequency is less than fifty percent or a calibratable threshold.

6. The method of claim 4, wherein:
the first short range wireless communications system comprises a first Wi-Fi radio system;
the second short range wireless communications system comprises a second Wi-Fi radio system; and
the multiple different communication conditions comprise a plurality of different operating frequencies for the first and second Wi-Fi radio systems.

7. The method of claim 6, wherein the null packets are transmitted from the first Wi-Fi radio system to the second Wi-Fi radio system internal to the vehicle when an engine of the vehicle is turned on.

8. The method of claim 6, wherein the multiple different communication conditions comprise:
a first operating frequency of 2.4 GHz for the first and second Wi-Fi radio systems; and
a second operating frequency of 5 GHz for the first and second Wi-Fi radio systems.

9. The method of claim 4, wherein:
the first short range wireless communications system comprises a first Bluetooth low energy (BLE) radio system;
the second short range wireless communications system comprises a second BLE radio system; and
the multiple different communication conditions comprise a plurality of different operating channels for the first and second BLE radio systems.

10. The method of claim 9, wherein the null packets are transmitted from the first BLE radio system to the second BLE radio system when an engine of the vehicle is turned off.

11. The method of claim 9, wherein the multiple different communication conditions comprise:
a first operating channel 37, corresponding to 2402 MHz, for the first and second BLE radio systems; and
a second operating channel 38 or 39, corresponding to 2426 or 2480 MHz, for the first and second BLE radio systems.

12. The method of claim 9, wherein the multiple different communication conditions comprise:
a first operating channel 37, corresponding to 2402 MHz, for the first and second BLE radio systems; and
multiple second operating channels 38 and 39, corresponding to both 2426 and 2480 MHz, for the first and second BLE radio systems.

13. The method of claim 1, further comprising:
initiating a channel of communications between the vehicle and a remote server that is remote from the vehicle, via a cellular communications system of the vehicle utilizing a cellular network in accordance with instructions provided by the processor;
monitoring a heartbeat of continuous communications between the vehicle and the remote server along the cellular network, via the processor; and
confirming whether or not the jamming event has actually occurred, based on the monitoring of the heartbeat of the continuous communications between the vehicle and the remote server along the cellular network via the processor.

14. A method for detecting a jamming event for a vehicle, the method comprising:
providing communications between the vehicle and a remote server that is remote from the vehicle, via a long range communications system of the vehicle utilizing a wireless network in accordance with instructions provided by a processor of the vehicle;
monitoring a heartbeat of continuous communications between the vehicle and the remote server along the wireless network, via the processor;
determining, via the processor using sensor data obtained from one or more sensors of the vehicle, one or more quantitative measures pertaining to the heartbeat of continuous communications between the vehicle and the remote server along the wireless network via the processor; and
determining, via the processor, whether a jamming event has occurred against the vehicle, based on the one or more quantitative measures pertaining to the heartbeat of continuous communications between the vehicle and the remote server along the wireless network.

15. The method of claim 14, further comprising:
taking a vehicle control action, in accordance with instructions provided by the processor, when it is determined by the processor that a jamming event has occurred.

16. The method of claim 14, wherein the heartbeat of continuous communications are provided between a cellular communications system of the vehicle and the remote server using a cellular network in accordance with instructions provided by the processor.

17. The method of claim 16, wherein the one or more quantitative measures used to determine whether a jamming event has occurred comprise one or more of a received signal strength indicator (RSSI), a reference signal received quality (RSRQ), or both, of signals that are sent from the cellular communications system of the vehicle to the remote server using the cellular network.

18. The method of claim 16, wherein the one or more quantitative measures used to determine whether a jamming event has occurred comprise both (i) a received signal strength indicator (RSSI); and (ii) a reference signal received quality (RSRQ), or both, of signals that are sent from the cellular communications system of the vehicle to the remote server using the cellular network.

19. The method of claim 14, further comprising:
confirming, via the processor, whether a jamming event has occurred against the vehicle, based on monitoring of intra-vehicle transmissions between multiple short range wireless communications systems of the vehicle that are disposed on opposing sides of the vehicle.

20. A vehicle comprising:
a body;
a first short range wireless range communications system with a first antenna disposed at a front end of the body, the first short range wireless communications system comprising a Wi-Fi radio system or a Bluetooth lower energy (BLE) system;
a second short range wireless communications system with a second antenna disposed at a rear end of the body, opposite the front end, the first short range wireless communications system also comprising a Wi-Fi radio system or a Bluetooth lower energy (BLE) system;
a long range cellular communications system comprising a cellular antenna disposed on the body;
a plurality of sensors configured to monitor communications of the first short range wireless communications system, the second short range wireless communications system, and the long range cellular communications system and to generate sensor data based on the monitoring; and
a processor that is coupled to the first short range wireless communications system, the second short range wireless communications system, the long range cellular communications system, and the plurality of sensors, the processor configured to at least facilitate:
instructing the first short range wireless communications system to transmit a plurality of null packets via intra-vehicle communications to the second short range wireless communications system of the vehicle under multiple different communication conditions comprising multiple different transmission frequency levels, multiple different operating channels, or both;
monitoring, using the sensor data, which of the null packets that are transmitted by the first short range wireless communications system are actually received by the second short range wireless communications system, under each of the multiple different communication conditions;
determining a frequency with which the null packets submitted from the first short range wireless communications system are actually received by the second short range wireless communications system;
performing, via the processor, an initial determination as to whether a jamming event has occurred for the vehicle, based on the frequency, via the monitoring at each of the multiple different communication conditions;
initiating a channel of communications between the vehicle and a remote server that is remote from the vehicle, via the long range cellular communications system of the vehicle utilizing a cellular network in accordance with instructions provided by the processor;
monitoring a heartbeat of continuous communications comprising signals between the vehicle and the remote server along the cellular network; and
determining a plurality of quantitative measures, comprising both (i) a received signal strength indicator (RSSI); and (ii) a reference signal received quality (RSRQ), of the signals that are sent from the long range cellular communications system of the vehicle to the remote server using the cellular network;
confirming whether or not the jamming event has actually occurred, based on the monitoring of the heartbeat of the continuous communications between the vehicle and the remote server along the cellular network, including based on the RSSI and the RSRQ; and
taking a vehicle control action, including by inhibiting operation of a steering column, engine, or both, of the vehicle, when it is determined by the processor that a jamming event has occurred against the vehicle.
